(19) United States
(12) Patent Application Publication
(10) Pub. No.: US 2017/0075853 A1
(43) Pub. Date: Mar. 16, 2017

(54) UNIVERSAL SERIAL BUS DEVICE, ELECTRONIC APPARATUS INCLUDING THE SAME, AND CONTROL METHOD THEREOF

(71) Applicant: SAMSUNG ELECTRONICS CO., LTD., Suwon-si (KR)

(72) Inventors: Min-suk SEO, Suwon-si (KR); Jeong-kee PARK, Seongnam-si (KR); Jung-hoon KIM, Hwaseong-si (KR); Hyun-ho KIM, Seoul (KR)

(73) Assignee: SAMSUNG ELECTRONICS CO., LTD., Suwon-si (KR)

(21) Appl. No.: 15/250,181

(22) Filed: Aug. 29, 2016

(30) Foreign Application Priority Data
Sep. 11, 2015 (KR) 10-2015-0129329

(51) Int. Cl. G06F 13/42; G06F 1/32; G06F 13/40

(52) U.S. Cl. CPC G06F 13/4282; G06F 13/4022; G06F 1/3287

(57) ABSTRACT

A universal serial bus (USB) device, an electronic apparatus including the same and a control method thereof are provided. The electronic apparatus includes a signal transceiver configured to transmit and receive a signal to and from an external apparatus; a first processor configured to communicate with the external apparatus; a switching unit configure to selectively supply a signal generating power to a signal transmission line between the signal transceiver and the first processor; a second processor configured to control the switching unit to generate a conversion signal corresponding to a predetermined event signal if the signal received from the external apparatus comprises the predetermined event signal; and a third processor configured to control the first processor to communicate with the external apparatus if the conversion signal is received.

### CROSS-REFERENCE TO RELATED APPLICATION

This application claims priority from Korean Patent Application No. 10-2015-0129329, filed on Sep. 11, 2015 in the Korean Intellectual Property Office, the disclosure of which is incorporated herein in its entirety by reference.

### BACKGROUND

Field

Apparatuses and methods consistent with exemplary embodiments relate to a universal serial bus (USB) device, an electronic apparatus including the same and a control method thereof, and more particularly to a USB device, an electronic apparatus including the same and a control method thereof, which are able to generate a conversion signal of complementary metal-oxide semiconductor (CMOS)/transistor-transistor logic (TTL) level corresponding to a signal of USB voltage level inputted to the USB device.

Description of Related Art

An electronic apparatus, such as a television (TV) or the like, is generally configured to have a normal mode for normal operation and a standby mode for power saving. According to a recent power consumption standard, the electronic apparatus is required to use, for example, 0.5 Watt or less in the standby mode.

An electronic device may receive a user input in the standby mode to enter the normal mode. For example, when a power on command is received from a user through a remote control or a manipulation panel in a power off state, the electronic device enters the normal mode and operates.

Recently, in order to support a wireless communication function, such as WiFi, Bluetooth, or the like, as well as a manipulation command by the remote control or the manipulation panel, a USB device is used.

However, as shown in FIG. 1, a related art electronic apparatus 10, which uses a USB device 11, needs a USB hub 12. When the electronic apparatus 10 receives a signal through the USB device 11 from an external apparatus in the standby mode, the USB hub 12 converts the signal of USB voltage level received at the USB device 11 into a signal of CMOS/TTL level in order to transmit the signal of the USB device 11 to a sub-processor 14 to wake up a main processor 13 from the standby mode to operate in a normal mode. There is, however, a problem in that the USB hub increases manufacturing costs of the electronic apparatus.

### SUMMARY

Exemplary embodiments address at least the above problems and/or disadvantages and other disadvantages not described above. Also, the exemplary embodiments are not required to overcome the disadvantages described above, and may not overcome any of the problems described above.

According to an aspect of an exemplary embodiment, there is provided an electronic apparatus including a signal transceiver configured to transmit and receive a signal to and from an external apparatus; a first processor configured to communicate with the external apparatus based on the signal received and transmitted through the signal transceiver; a switching unit configure to selectively supply a signal generating power to a signal transmission line between the signal transceiver and the first processor; a second processor configured to control the switching unit to generate a conversion signal corresponding to a predetermined event signal if the signal received from the external apparatus comprises the predetermined event signal; and a third processor configured to control the first processor to communicate with the external apparatus if the conversion signal is received.

The switching unit may include a resistor connected to a signal generating power; and a switch disposed between the resistor and the signal transmission line. The resistor may include a pullup resistor and the switch may include a bipolar junction transistor.

The second processor may control the switching unit to turn on and off to generate a conversion signal having a waveform corresponding to information included in the event signal. Here, the information included in the event signal may include information related to a specific event and a type of the external apparatus.

The second processor may control the switching unit to turn on and off to generate a conversion signal in which one of a pulse number, a pulse width and a duty ratio is different according the information included in the event signal.

The third processor may control the first processor to communicate with the external apparatus in a standby mode in which the first processor is in a sleeping mode state or a power saving mode state.

The electronic apparatus may further include a display configured to display an image. The third processor may control the first processor to display information included in the event signal corresponding to the conversion signal on the display if the conversion signal is received.

According to an aspect of another exemplary embodiment, there is provided a universal serial bus (USB) device including a connector detachably connected to an electronic apparatus; a signal transceiver configured to transmit and receive a signal to and from an external apparatus to communicate with the electronic apparatus to which the connector is connected; a switching unit configured to selectively supply a signal generating power to a signal transmission line between the signal transceiver and the electronic apparatus; and a processor configure to control the switching unit to generate a conversion signal corresponding to a predetermined event signal if the signal received from the external apparatus comprises the predetermined event signal.

The switching unit may include a resistor connected a signal generating power; and a switch disposed between the resistor and the signal transmission line. The resistor may include a pullup resistor and the switch may include a bipolar junction transistor.

The processor may control the switching unit to turn on and off to generate a conversion signal having a waveform corresponding to information included in the event signal. Here, the information included in the event signal may include information related to a specific event and a type of the external apparatus.

The processor may control the switching unit to turn on and off to generate a conversion signal in which one of a pulse number, a pulse width and a duty ratio is different according the information included in the event signal.

### BRIEF DESCRIPTION OF THE DRAWINGS

The above and/or other aspects will become apparent and more readily appreciated from the following description of exemplary embodiments, taken in conjunction with the accompanying drawings, in which:

FIG. 1 is a block diagram showing a related art electronic apparatus including a USB device;

FIG. 2 is a block diagram showing an electronic apparatus including a USB device according to an exemplary embodiment;

FIG. 3 is a waveform diagram showing an example of a signal received at a USB device of an electronic apparatus according to an exemplary embodiment;

FIG. 4 is a circuit diagram showing a switching unit of an electronic apparatus including a USB device according to an exemplary embodiment;

FIGS. 5 to 8 are waveform diagrams showing examples of a signal generated by a switching unit of an electronic apparatus according to an exemplary embodiment;

FIG. 9 is a block diagram showing an electronic apparatus including a USB device according to another exemplary embodiment; and

FIG. 10 is a flow chart showing an operation of an electronic apparatus including a USB device according to an exemplary embodiment.

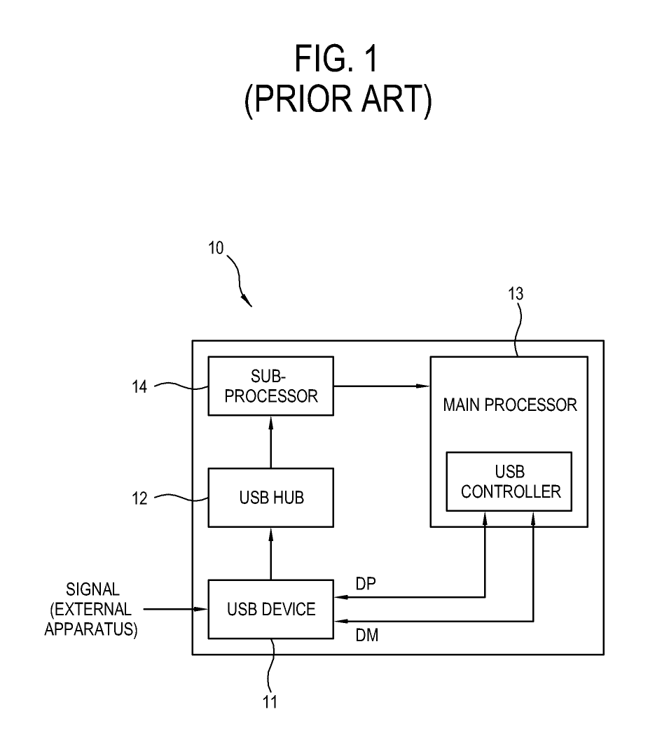

### DETAILED DESCRIPTION OF EXEMPLARY EMBODIMENTS

Exemplary embodiments will be described in detail with reference to accompanying drawings. The present disclosure may be achieved in various forms and not limited to the following embodiments. For convenience of description, parts not directly related to the present disclosure are omitted, and like numerals refer to like elements throughout.

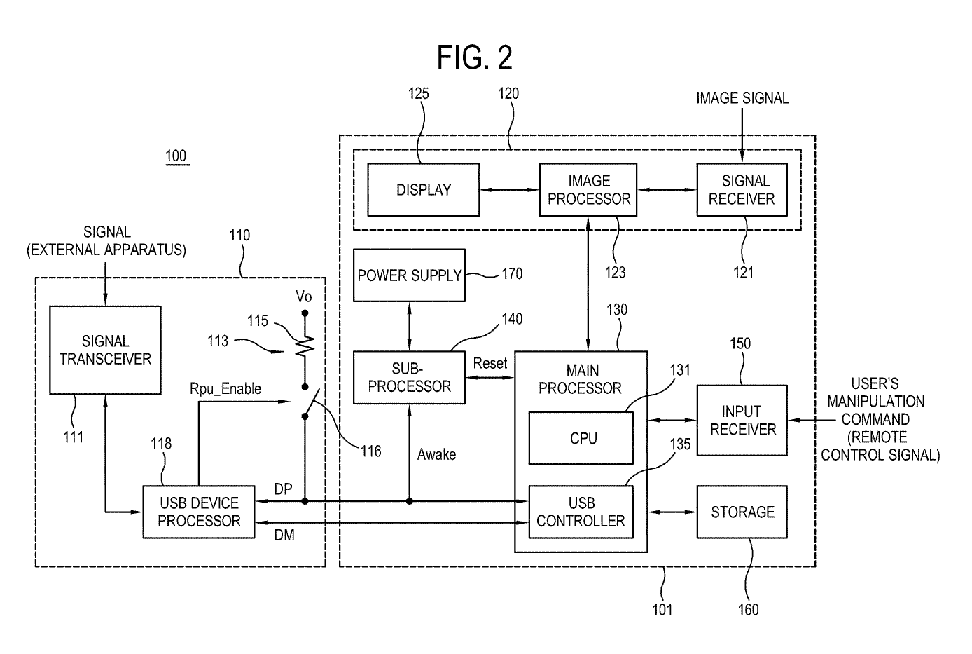

FIG. 2 is a block diagram showing an electronic apparatus 100 including a USB device 110 according to an exemplary embodiment.

The electronic apparatus 100 according to an exemplary embodiment is an electronic device capable of communicating with an external apparatus and having a display function. The electronic apparatus 100 may be configured as, for example, a television (TV), a personal computer, a notebook computer, a home appliance such as an internet refrigerator, or other similar electronic device.

The electronic apparatus 100 according to an exemplary embodiment has a normal mode for normal operation and a standby mode for power saving. In the standby mode, power is not supplied to main components of the electronic apparatus 100 which consume relatively greater power, and only subcomponents of the electronic apparatus 100 which use relatively less power are operating. For example, in a normal mode, the electronic apparatus 100, such as a TV, switches to the standby mode if a power off command is input to an input receiver 150 through a remote controller (not shown) or a manipulation panel (not shown) or if there is no signal or command input to the input receiver 150 for a predetermined time.

In the standby mode, the components of the electronic apparatus 100 consume a preset level or less of power. When a user input is received in the standby mode, the electronic apparatus 100 wakes up from the standby mode to the normal mode and operates normally. For example, when a power on command is input in the standby mode, the electronic apparatus 100 may return to the normal mode according to the power on command or an input of an event signal through the USB device 110.

Referring to FIG. 2, the electronic apparatus 100 according to an exemplary embodiment may include a USB device 110, an operation implementer 120, a main processor 130, a sub-processor 140, an input receiver 150, a storage 160, and a power supply 170.

The USB device 110 is a communication device capable of transmitting and receiving a signal to and from the external apparatus. The USB device 110 performs a wireless communication function of the electronic apparatus 100 and a function of converting an event signal of USB voltage level received thereto in the standby mode into a signal of CMOS/TTL level of the electronic apparatus 100. Here, the external apparatus may be configured as a door sensing device, a gas valve sensing device, an electric light sending device, a refrigerator, a washing machine, an air conditioner or other similar electronic device, in which a communicator (not shown) capable of transmitting and receiving a signal to and from the electronic apparatus 100 is provided to be connected in a network with the electronic apparatus 100.

The USB device 110 may include a signal transceiver 111, a switching unit 113, and a USB device processor 118. The USB device 110 according to an exemplary embodiment may be configured as a dongle capable of supporting a wireless communication function such as WiFi, Bluetooth, infrared transmission or the like. The dongle may be integrally built in a casing 101 of the electronic apparatus 100 or detachably connected to a USB connector (not shown) provided in the casing 101. If the dongle is detachably connected to the USB connector of the casing 101, it is provided with a counterpart connector.

The signal transceiver 111, which is a communicator capable of transmitting and receiving a signal, transmits a signal received from the USB device processor 118 to the external apparatus and receives a signal from the external apparatus to transmit to the USB device processor 118.

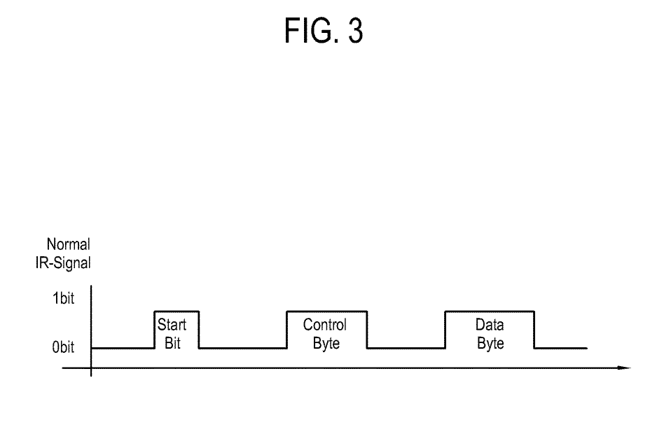

FIG. 3 is a waveform diagram showing an example of a signal received at a USB device of an electronic apparatus according to an exemplary embodiment. Referring to FIG. 3, the signal received from the external apparatus may be configured as a signal of wireless or infrared frequency band having a bit pulse form. For example, the signal may be configured in a pulse format including a start bit pulse StartBit, a control byte pulse ControlByte and a data byte pulse DataByte.

The start bit pulse StartBit is a signal indicating that a specific external apparatus transmits the signal to the electronic apparatus 100. The data byte pulse DataByte is a signal related to data corresponding to a specific event, content, or the like, which is transmitted to the electronic apparatus 100. In the external apparatus, the data is encoded in a pulse form through a signal encoder (not shown) to transmit through a corresponding signal transmitting and receiving unit (not shown) to the electronic apparatus 100. The control byte pulse ControlByte is a signal indicating a type, a length, a byte index, etc. of data being transmitted.

If an event is generated or a content is transmitted by a user's manipulation, the external apparatus transmits a pulse signal as shown in FIG. 3 as an event or content signal. The external apparatus first transmits a start bit pulse StartBit, and at certain intervals, a control byte pulse ControlByte and a data byte pulse DataByte corresponding to the event or content.

The switching unit 113 disposed between an operation power Vo and a signal transmission line DP or DM switches to connect or disconnect between the operation power Vo and the signal transmission line DP or DM under a control of the USB device processor 118. The operation power Vo is a power for driving the USB device processor 118 or the like. The operation power Vo is supplied through a transformer (not shown) from the power supply 170. The operation power Vo may be 3.3 V or 5 V. The signal transmission line DP or DM is dispose between the USB device processor 118 and the USB controller 135 of the main processor 130 to transmit a signal therebetween.

The switching unit 113 according to an exemplary embodiment may include a resistor 115 and a switch 116. The resistor 115 is connected to the operation power Vo and the switch 116 is disposed between the resistor 115 and the signal transmission line DP or DM. Here, the resistor 115 may include a pullup resistor of 1.5 Kohm and 3.3 V and the switch 116 may include a bipolar junction transistor (BJT), such as an n-p-n type transistor.

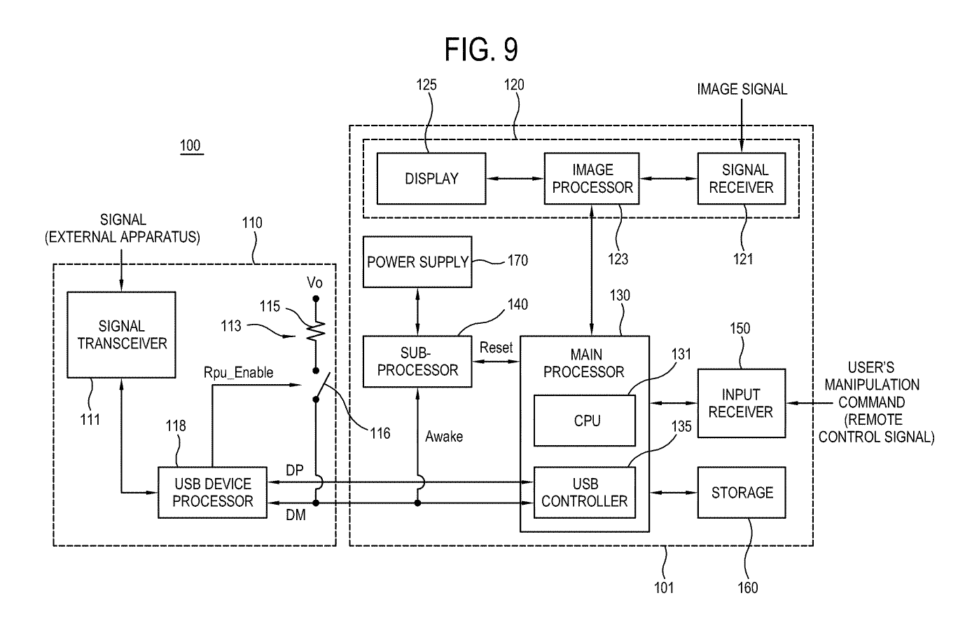

If the USB device 110 is a full speed/high speed device, the switching unit 113 may be disposed between the operation power Vo and a Data+ signal transmission line DP, as shown in FIG. 2. If the USB device 110 is a low speed device, the switching unit 113 may be disposed between the operation power Vo and a Data− signal transmission line DM, as shown in FIG. 9.

Accordingly, the switching unit 113 converts a voltage flowing through the signal transmission line DP or DM into 0 V to 3.3V receivable by the sub-processor 140 to generate a conversion signal in a waveform corresponding to the event signal as the switch 116 is turned on or off under the control of the USB device processor 118, as described below.

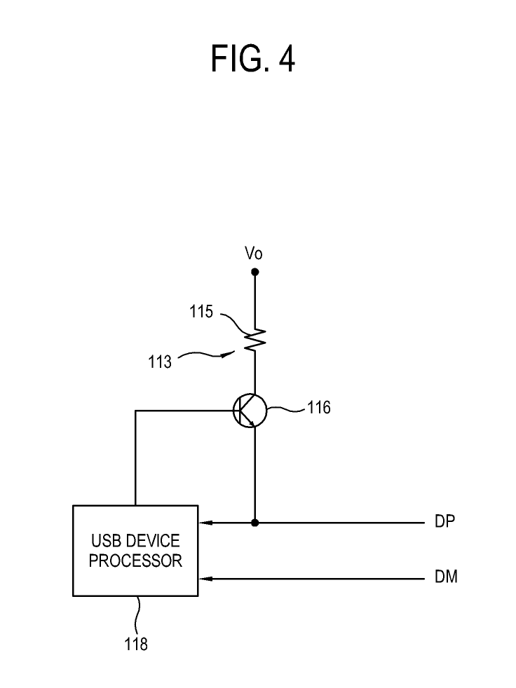

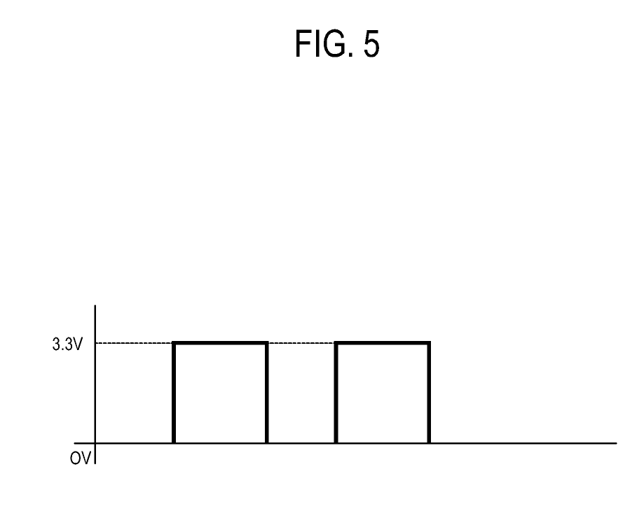

For example, as shown in FIG. 4, if the switch 116 is a n-p-n type transistor, when the USB device processor 118 generates a high signal as a first pullup resistor enable signal, the switch 116 is turned on, and thus a voltage of the signal transmission line DP or DM comes to 3.3 V by the pullup resistor 115 of 3.3 V. On the other hand, when the USB device processor 118 generates a low signal as the first pullup resistor enable signal, the switch 116 is turned off, and thus a voltage of the signal transmission line DP or DM is changed to 0 V. As the switch 116 is turned on or off according to the high signal or the low signal of the USB device processor 118, a conversion signal in a corresponding waveform as shown in FIGS. 5 to 8 is generated in the signal transmission line DP or DM. The generated conversion signal is transmitted to the USB controller 135 and the sub-processor 140 connected to the signal transmission line DP or DM.

The USB device processor 118 determines whether the signal received through the signal transmission line DP or DM is a predetermined event signal, and if it is determined that the received signal is the predetermined event signal, controls the switching unit 113 to generate a conversion signal corresponding to the predetermined event signal.

When a signal is received through the signal transceiver 111, the USB device processor 118 analyses the received signal in a pulse form as shown in FIG. 3 to determine whether the received signal is a predetermined event signal. For example, the USB device processor 118 may determine whether the received signal is a predetermined event signal by decoding the received signal and matching the decoded signal with event signals previously stored in an internal memory thereof. At this time, the internal memory may store various event signals predetermined according to a type of the external apparatuses and a content of events. Here, the events may include an opening and/or a battery consumption of a front door, an opening of a gas valve, a lighting of various electric lights, an opening of door, a shortage of water for ice making and/or an abnormal operation in a refrigerator, a washing completion, a beginning of washing reservation and/or an abnormal operation in a washing machine, a filter cleaning time and/or an abnormal operation in an air conditioner, etc.

If there is an event signal matched with the received signal from among the previously stored event signals, the USB device processor 118 generates a first pullup resistor enable signal to the switch 116 of the switching unit 113 to turn on and off the switch 116 so as to generate a conversion signal corresponding to the matched event signal.

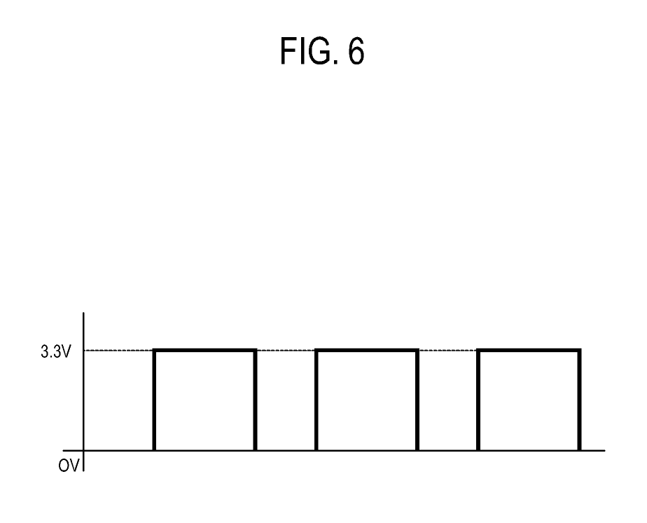

For example, if the event signal is a door opening event signal received from a door sensing device mounted on a front door when the front door is opened, a conversion signal having two pluses may be generated, as shown in FIG. 5. Also, if the event signal is a gas valve opening event signal received from a gas valve sensing device mounted on a gas valve when the gas valve is opened, a conversion signal having two pluses may be generated, as shown in FIG. 6. Here, the USB device processor 118 regularly generates a high signal and a low signal as the first pullup resistor enable signal.

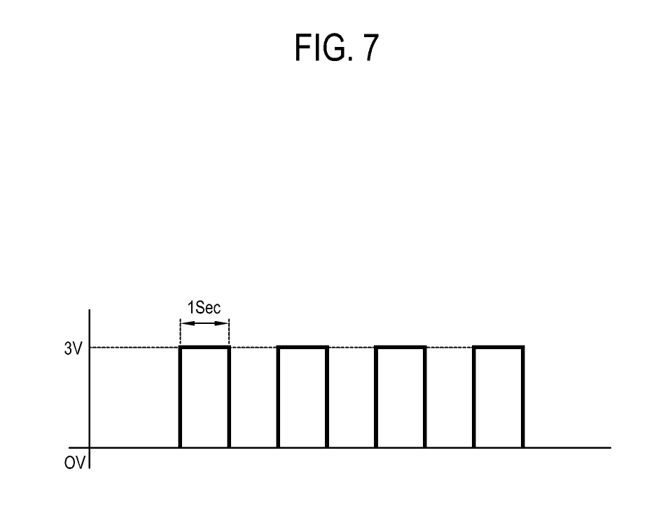

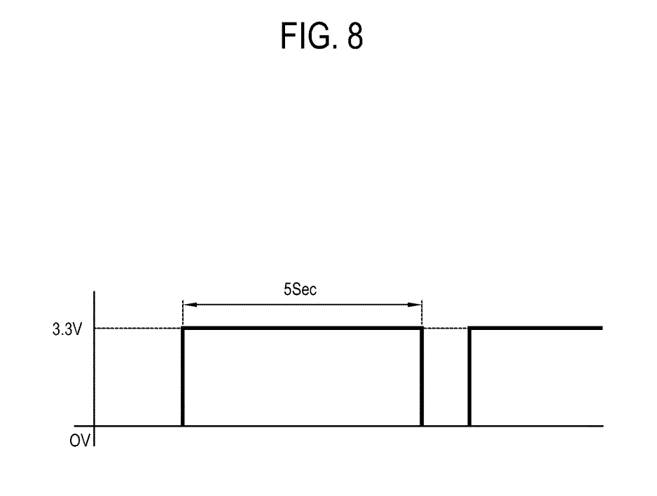

Alternatively, the conversion signal may be generated to have different pulse width or different duty cycle or ratio according to the event signals. For example, if the event signal is the door opening event signal, the conversion signal having a pulse width of one second may be generated, as shown in FIG. 7. Also, if the event signal is the gas valve opening event signal, the conversion signal having a pulse width of five seconds may be generated, as shown in FIG. 8. Here, the USB device processor 118 adjusts time durations for high and low signals to comply with the pulse width corresponding to the corresponding event signal.

Although the USB device processor 118 has been explained as immediately generating the first pullup resistor enable signal to generate the conversion signal through the switch 116 if there is the event signal matched with the received signal from among the previously stored event signals, the exemplary embodiment is not limited thereto.

For example, the USB device processor 118 may generate the first pullup resistor enable signal to generate the conversion signal through the switch 116 only if the electronic apparatus 100 is in the standby mode. The standby mode may be determined by a standby mode entering notification signal. The standby mode entering notification signal is generated and transmitted by the USB controller 135 of the main processor 130 just before the main processor 130 enters a standby mode state (e.g., a turned-off state, a power saving state or a sleeping mode state). The USB device processor 118 determines that the electronic apparatus 100 enters the standby mode, if it receives the standby mode entering notification signal, and determines that the electronic apparatus 100 enters the normal mode if the USB controller 135 wakes up from the standby mode state to resume a communication with the USB device processor 118 in a state determined as the standby mode.

If there is no event signal matched with the received signal from among the previously stored event signals, the USB device processor 118 does not generate the first pullup resistor enable signal to the switch 116 of the switching unit 113, but transmits the received signal to the USB controller 135 of the main processor 130.

Also, if the USB device 110 is detachably connected to the USB connector of the casing 101, the USB device processor 118 may generate a second pullup resistor enable signal to the switch 116 to turn on and off the switch 116 so as to generate an inserting notification signal, when the USB device 110 is connected to the USB connector. Here, the inserting notification signal may be generated to have a waveform different from the conversion signal.

The USB device processor 118 according to an exemplary embodiment may be configured as a microcontroller configured to perform the operation as described above.

Referring again to FIG. 2, the operation implementer 120 performs a predetermined operation of the electronic apparatus 100. For example, if the electronic apparatus 100 is a TV, the operation implementer 120 may include a signal receiver 121, an image processor 123, and a display 125.

The signal receiver 121 receives an image signal included in a broadcast signal such as a TV broadcast signal transmitted from a broadcast signal transmitting device (not shown), receives an image signal from an imaging device, such as a DVD player and a BD player, receives an image signal from a PC, receives an image signal from a mobile terminal, such as a smart phone, receives an image signal through a network, such as the Internet, and/or receives an image content stored in a storage medium, such as a USB storage medium, as an image signal.

The image processor 123 processes an image signal received by the signal receiver 121 to display an image. The image processor 123 may perform decoding, image enhancing or scaling functions.

The display 125 displays an image based on an image signal processed by the image processor 123. The display 125 may display an image by any method and include a display panel (not shown) to display an image, such as a liquid crystal display (LCD), a plasma display panel (PDP), and an organic light emitting diode (OLED), and a panel driver (not shown) to perform timing control to display an image signal on the display panel.

The operation implementer 120 may perform various operations based on functions of the electronic apparatus 100, without being limited thereto. The operation implementer 120 is supplied with power from the power supply 170 and operates normally in the normal mode, and may not be supplied with power for power saving in the standby mode. In FIG. 2, lines for supplying power from the power supply 170 to the components are not shown for convenience.

The main processor 130 is a main controller of the electronic apparatus 100, which controls an operation of the operation implementer 120. The main processor 130 includes a central processing unit (CPU) 131 and operates by running a control program.

The main processor 130 may further include a nonvolatile memory, such as a flash memory to store the control program, and a double data rate (DDR) volatile memory to load at least part of the stored control program for the CPU to quickly access. The control program of the main processor 130 is programmed with contents to control the operation of the operation implementer 120.

The main processor 130 may further include a USB controller 135. The USB controller 135 is a communicator, which performs a transmission with the external apparatus based on a signal transmitted and received through the signal transceiver 111 of the USB device 110 in the normal mode.

Alternatively, the USB controller 135 may transmit the standby mode entering notification signal to the USB device processor 118 just before the main processor 130 enters the standby mode state, so that the USB device processor 118 perceives that the electronic apparatus 100 enters the standby mode. The USB device processor 118 perceives that a present mode of the electronic apparatus 100 is the standby mode.

The USB controller 135 according an exemplary embodiment may be configured as a USB controller chip configured to perform the operation as described above.

The main processor 130 is supplied with power from the power supply 170 to operate normally in the normal mode and comes to a turned-off state which is not supplied with power, or a power saving state or sleeping mode state which is maintained in a low power, in the standby mode. Accordingly, in the normal mode, the USB controller 135 of the main processor 130 can transmit a signal to the USB device processor 118 or process a signal received from the USB device processor 118, but in the standby mode, the USB controller 135 cannot transmit the signal to the USB device processor 118 or process the signal received from the USB device processor 118.

The sub-processor 140 may process signals received from the switching unit 113 and the USB device processor 118 in the standby mode. For example, when receiving the conversion signal through the signal transmission line DP or DM from the switching unit 113, the sub-processor 140 transmits a wake-up signal to the main processor 130. With the reception of the wake-up signal from the sub-processor 140, the main processor 130 wakes up from the standby mode and operates in the normal mode. Here, the sub-processor 140 may control a switch (not shown) of the power supply 170 to supply power to the main processor 130.

Also, when receiving the conversion signal from the switching unit 113 in the standby mode, the sub-processor 140 controls the CPU 131 of the main processor 130 to perform an operation corresponding to the conversion signal.

For example, if the conversion signal is a signal corresponding to the door opening event signal, the sub-processor 140 may control the CPU 131 to display a notification message or an image notifying that the front door is opened from among a plurality of notification messages or images stored in the storage 160, on the display 125.

When receiving the conversion signal from the switching unit 113 in the normal mode, the sub-processor 140 ignores the conversion signal and thus the USB controller 135 performs a processing to the conversion signal. Here, since the USB controller 135 is wakened up, it can control the CPU 131 of the main processor 130 to perform the operation corresponding to the conversion signal.

As described above, in the standby mode, the sub-processor 140 receives the conversion signal of CMOS/TTL level generated through the switching unit 113 under the control of the USB device processor 118, wakes up the main processor 130, and controls the CPU 131 of the main processor 130 to perform the operation corresponding to the conversion signal. Accordingly, the electronic apparatus 100 does not need a separate circuit configuration, such as a USB hub, when the USB device processor receives an event signal in the standby mode, which converts the event signal of USB voltage level into the signal of CMOS/TTL level in order to transmit the event signal (or the wake-up signal corresponding to the event signal) of the USB voltage level to the sub-processor, as in the related art electronic apparatus.

After displaying the notification message or image according to the conversion signal, if there is no signal input to the input receiver 150 through the remote controller or the manipulation panel for a predetermined time or a power off command is received through the remote controller or the manipulation panel, the sub-processor 140 returns to the power saving state of the standby mode according to a control signal of the CPU 131 of the main processor 130, and controls the power supply 170 not to supply power to the main processor 130.

If receiving the inserting notification signal from the switching unit 113 in the normal mode, the sub-processor 140 ignores the inserting notification signal and the USB controller 135 performs a processing to the inserting notification signal. Here, the USB controller 135 controls the CPU 131 of the main processor 130 to display a notification message or image corresponding to the inserting notification signal from a plurality of notification message or image stored in the storage 160, on the display 125.

The sub-processor 140 according to an exemplary embodiment may be configured as a microcontroller capable of processing input signals. The sub-processor 140 has relatively low power consumption as compared with that of the main processor 130.

The input receiver 150 receives an input signal. The input signal may include, for example, a power on command or a power off signal through the remote controller or the manipulation panel.

The storage 160 stores notification messages or images predetermined corresponding to the conversion signal and notification messages or images predetermined corresponding to the inserting notification signal. According to a control of the sub-processor 140, the CPU 131 of the main processor 130 displays a notification message or image corresponding to the conversion signal or the inserting notification signal from among the notification messages or images stored in the storage 160, on the display 125.

In the standby mode, the operation implementer 120 and the main processor 130, which consume relatively greater power, and the storage 160 in which operation is unnecessary, come to a turned off state, a power saving state or a sleep mode state, while the input receiver 150, which consumes relatively less power and receives input signals through the remote controller or the manipulation panel, and the USB device 110 in which operation is necessary are supplied with power and operate.

Meanwhile, the sub-processor 140 is in the power saving state or the sleep mode state, which does not operate and does not consume power basically to save power in the standby mode. However, when the conversion signal is input, the sub-processor 140 intermittently operates to process the input signal. In this case, the sub-processor 140 may consume power.

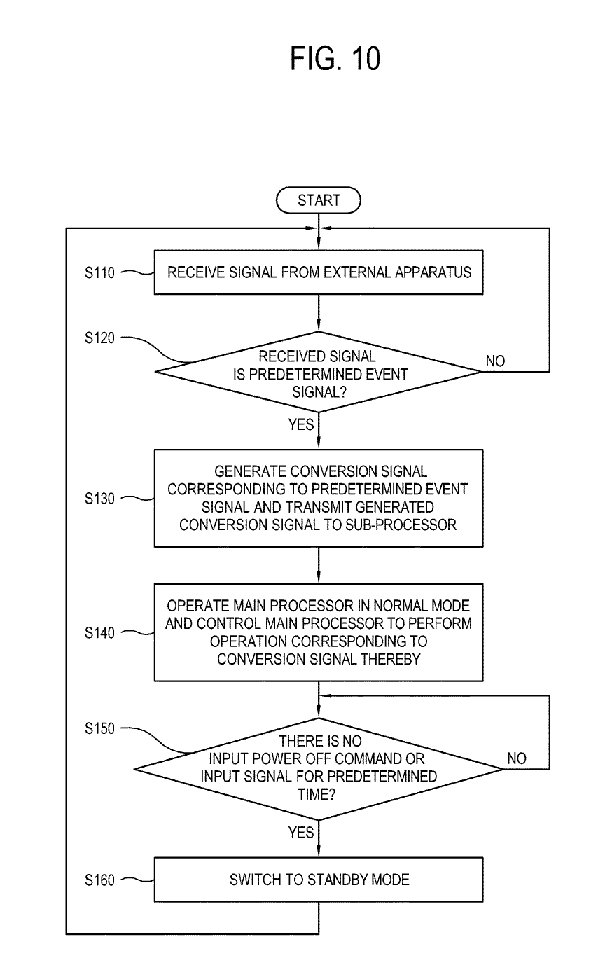

FIG. 10 is a flowchart showing an operation of an electronic apparatus 100 including a USB device according to an exemplary embodiment.

Referring to FIG. 10, when the electronic apparatus 100 is in the normal mode, even though a signal, such as an event signal or the like, is received through the signal transceiver 111 from the external apparatus, the USB controller 135 of the main processor 130 can process the received signal since it is wakened up. Accordingly, it is assumed that the electronic apparatus 100 is in the standby mode. Also, it is assumed that the signal received through the signal transceiver 111 from the external apparatus is an event signal. As described above, in the standby mode, the operation implementer 120 and the main processor 130 are in a state which does not consume power.

First, at an operation S110, the USB device 110 receives a signal from external apparatus in the standby mode.

Next, at an operation S120, the USB device processor 118 analyses the received signal and determines whether the received signal is a predetermined event signal.

If the received signal is the predetermined event signal, at an operation S130, the USB device processor 118 controls the switching unit 113 to generate a conversion signal corresponding to the predetermined event signal to transmit to the sub-processor 140. For example, if the event signal is a door opening event signal transmitted from the door sensing device mounted on the front door when the front door is opened, the USB device processor 118 controls the switching unit 113 to transmit a conversion signal having two pulses as shown in FIG. 5, to the sub-processor 140.

At an operation S140, when receiving the conversion signal from the switching unit 113, the sub-processor 140 transmits a wake-up signal to the main processor 130 to operate in the normal mode, and controls the CPU 131 of the main processor 130 to perform an operation corresponding to the conversion signal. For example, according to a control of the sub-processor 140, the CPU 131 of the main processor 130 may control the display 125 to display a notification message or image indicating that the front door is opened from among a plurality of notification of messages or images stored in the storage 160.

Next, at an operation S150, if a power off command is received through the remote controller or the manipulation panel or there is no signal input to the input receiver 150 through the remote controller or the manipulation panel for a predetermined time, at an operation S160, the sub-processor 140 returns to the power saving state of the standby mode according to a control of the CPU 131 of the main processor 130, and controls the power supply 170 not to supply power to the main processor 130, thereby minimizing power consumption.

Thereafter, operations after the operation S100 are repeated.

According to the exemplary embodiments as described above, the USB device generates the conversion signal of CMOS/TTL level corresponding to the event signal of USB device, which is capable of being received by the sub-processor of the electronic apparatus, by using the operation power and the pullup resistor connected thereto. Accordingly, the electronic apparatus does not need a separate circuit configuration, such as a USB hub, which converts the signal of USB voltage level into the signal of CMOS/TTL level, as in the related art electronic apparatus. Thus, manufacturing cost of the electronic apparatus can be reduced.

Although a few exemplary embodiments have been shown and described, it will be appreciated by those skilled in the art that changes may be made in these exemplary embodiments without departing from the principles and spirit of the inventive concept. Therefore, the foregoing has to be considered as illustrative only. The scope of the inventive concept is defined in the appended claims and their equivalents. Accordingly, all suitable modification and equivalents may fall within the scope of the inventive concept.

What is claimed is:

1. An electronic apparatus comprising:
a signal transceiver configured to transmit and receive a signal to and from an external apparatus;
a first processor configured to communicate with the external apparatus based on the signal received and transmitted through the signal transceiver;
a switching unit configure to selectively supply a signal generating power to a signal transmission line between the signal transceiver and the first processor;
a second processor configured to control the switching unit to generate a conversion signal corresponding to a predetermined event signal if the signal received from the external apparatus comprises the predetermined event signal; and
a third processor configured to control the first processor to communicate with the external apparatus if the conversion signal is received.

2. The apparatus according to claim 1, wherein the switching unit comprises:
a resistor connected to a signal generating power; and
a switch disposed between the resistor and the signal transmission line.

3. The apparatus according to claim 2, wherein the resistor comprises a pullup resistor.

4. The apparatus according to claim 2, wherein the switch comprises a bipolar junction transistor.

5. The apparatus according to claim 1, wherein the second processor is further configured to control the switching unit to turn on and off to generate a conversion signal having a waveform corresponding to information included in the event signal.

6. The apparatus according to claim 5, wherein the information included in the event signal comprises information related to a specific event and a type of the external apparatus.

7. The apparatus according to claim 5, wherein the second processor is further configured to control the switching unit to turn on and off to generate a conversion signal in which one of a pulse number, a pulse width and a duty ratio is different according the information included in the event signal.

8. The apparatus according to claim 1, wherein the third processor is further configured to control the first processor to communicate with the external apparatus in a standby mode in which the first processor is in a sleeping mode state or a power saving mode state.

9. The apparatus according to claim 1, further comprising a display configured to display an image,
wherein the third processor is further configured to control the first processor to display information included in the event signal corresponding to the conversion signal on the display if the conversion signal is received.

10. A universal serial bus (USB) device comprising:
a connector detachably connected to an electronic apparatus;
a signal transceiver configured to transmit and receive a signal to and from an external apparatus to communicate with the electronic apparatus to which the connector is connected;
a switching unit configured to selectively supply a signal generating power to a signal transmission line between the signal transceiver and the electronic apparatus; and
a processor configure to control the switching unit to generate a conversion signal corresponding to a predetermined event signal if the signal received from the external apparatus comprises the predetermined event signal.

11. The device according to claim 10, wherein the switching unit comprises:
a resistor connected a signal generating power; and
a switch disposed between the resistor and the signal transmission line.

12. The device according to claim 11, wherein the resistor comprises a pullup resistor.

13. The device according to claim 11, wherein the switch comprises a bipolar junction transistor.

14. The device according to claim 10, wherein the processor is further configured to control the switching unit to turn on and off to generate a conversion signal having a waveform corresponding to information included in the event signal.

15. The device according to claim 14, wherein the information included in the event signal comprises information related to a specific event and a type of the external apparatus.

16. The device according to claim 14, wherein the processor is further configured to control the switching unit to turn on and off to generate a conversion signal in which one of a pulse number, a pulse width and a duty ratio is different according the information included in the event signal.
